(19) United States
(12) Patent Application Publication
(10) Pub. No.: US 2004/0219949 A1
(43) Pub. Date: Nov. 4, 2004

(54) Memory drive device for wirelessly accessing data

(76) Inventors: Steel Su, Taipei (TW); Toon Jeow Foo, Taipei (TW)

Correspondence Address: Han-Yi Lee, BAYSHORE PATENT GROUP, LLC., 520 Chantecler Dr., Fremont, CA, 94539, US

(21) Appl. No.: 10/704,489

(22) Filed: Nov. 8, 2003

(30) Foreign Application Priority Data
Apr. 30, 2003 (TW) 092206939

(51) Int. Cl. H04M 1/00

(52) U.S. Cl. 455/558

(57) ABSTRACT

A memory drive device for wirelessly accessing data comprises an USB interface connected to a computer, a microcontroller for processing, reading, writing, retrieving and moving data; a flash memory for storing data, connected to the microcontroller, an external memory interface for providing a connection to an external memory device, connected to the microcontroller, a wireless transceiver module for establishing a data communication chain with an external mobile electronic device, connected to the microcontroller, and a power supply to provide the work power needed by the memory drive device.

### FIELD OF THE INVENTION

The present invention relates to a storage device and, in particular, to a memory drive device for wirelessly accessing data. The present application is based on Taiwanese Patent Application No. 92206939, filed Apr. 30, 2003, which is incorporated herein by reference.

### BACKGROUND OF THE INVENTION

All prior art memory card electronic devices are connected to a computer with a connect interface, such as a USB interface. The computer can execute instructions of operating files—for example, copy or save, to retrieve or move data between the memory card electronic device and an internal storage device, such as a hard drive. The “Pen-type portable memory device” disclosed in the US patent no. 6,522,534 B1 is a practical example of the known art. However, the type of the memory card electronic device disclosed in the above patent can only retrieve and store data between a computer and a memory card electronic device. The memory card electronic device could not be accessed by other electronic devices, such as personal digital assistants (PDAs) nor directly read/write such devices. The above is an obvious defect.

U.S. Pat. No. 6,522,552B1 has disclosed a “wireless memory card reader” for reading/writing a memory card by way of a wireless arrangement.

However, in this disclosure, one cannot perceive a way to directly read/write other memory card electronic devices, such as a personal digital assistant.

The present invention is made to overcome the above-mentioned problems of the relate arts, and it is an object of the present invention to provide a memory drive device which can wirelessly access to data and automatically read/write the internal memory of an external device. An external device thereof could be a mobile electronic device, for example, a personal digital assistant, or an external memory device, for example, a CF card.

### SUMMARY OF THE INVENTION

An object of the present invention is to provide a memory drive device for wirelessly accessing data. The memory drive device can store backup data in the internal memory of a remote external device, such as a mobile electronic device (e.g. a personal digital assistant) or an external memory device (e.g. CF card) via wireless communication or by the insertion of a card.

It is a further object of the present invention to provide a memory drive device for wirelessly accessing data. This memory drive device can send and receive data with regard to a computer, an external electronic device, and an external memory device .

In order to accomplish the foregoing objects, the memory drive device for wirelessly accessing data of this invention comprises an USB interface connected to a computer; a microcontroller for processing, reading, writing, retrieving and moving data; a flash memory for storing data, connected to the microcontroller; an external memory interface for providing a connection to an external memory device, connected to the microcontroller; a wireless transceiver module for establishing a data communication chain with an external mobile electronic device, connected to the microcontroller; and a power supply to provide the work power needed by the memory drive device.

### BRIEF DESCRIPTION OF THE DRAWINGS

The features, functions, and advantages of the present invention will be readily understood upon a thoughtful deliberation of the following detailed description of the embodiments of the present invention with reference to the accompanying drawings:

FIG. 1 is a diagram of the circuit structure of the present invention;

FIG. 2 is a flow chart of the backup data process executed for the mobile electronic device of the present invention;

FIG. 3 is a flow chart of the backup data process executed for the external memory device of the present invention; and

FIG. 4 is a flow chart of the upgrading support process executed for the mobile electronic device of the present invention.

### DETAILED DESCRIPTION OF THE INVENTION

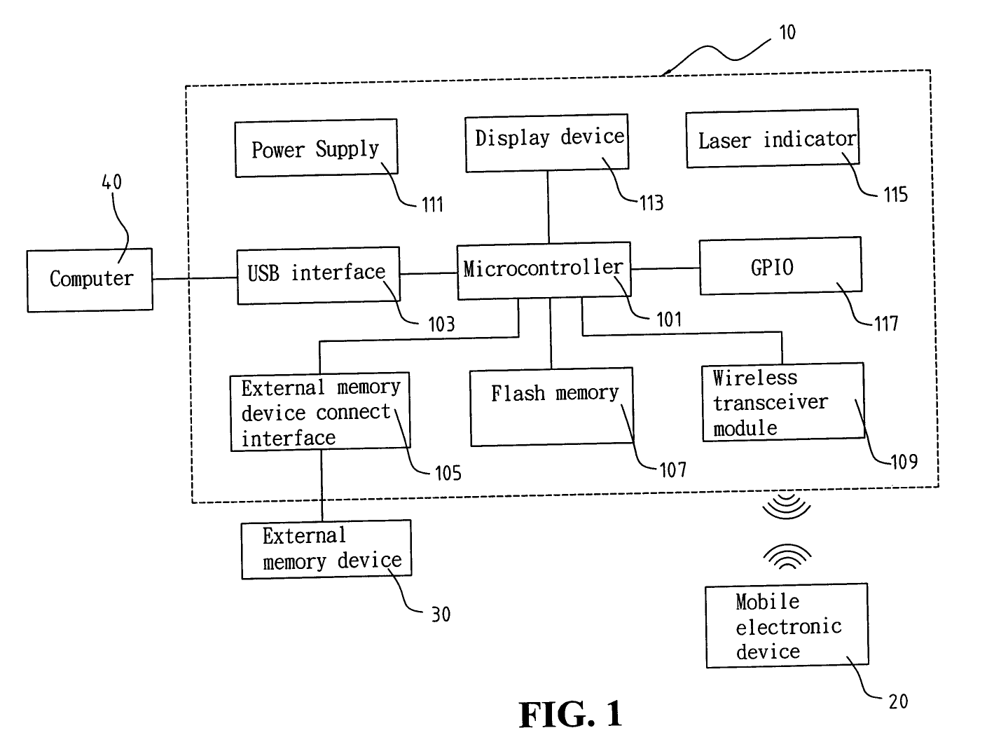

FIG. 1 shows the diagram of the circuit structure of the present invention. As shown in FIG. 1, the memory drive device 10 of the present invention is for wirelessly accessing data and comprises an USB interface 103 connected to a computer 40. The practical embodiment of USB interface 103 thereof could be USB1.0 or USB2.0 compliant. The memory drive device 10 further comprises a flash memory 107 being connected to the microcontroller 101 mainly for data storage. The memory drive device 10 further comprises an external memory device connect interface 105 being connected to the microcontroller 101 and to an external memory device 30, which is embodied in a CF (Compact Flash) card, a MMC (Multi Media Card) card, an SD (Secured Digital) card, a MS (Memory Stick) card, a MS-PRO (Memory Stick Pro) card, an SIM (Subscriber Identify Module) card, an SMARTCARD, a CD writer or others. The memory drive device 10 further comprises a wireless transceiver module 109 being connected to the microcontroller 101. The wireless transceiver module 109 thereof, with the external mobile electronic device 20 thereof, establishs a data communication chain. Through this data communication chain, the memory drive device 10 can access, read and write the mobile electronic device 20 thereof. The embodiment of the wireless transceiver module 109 thereof could be an infrared transceiver module or a Bluetooth module. The mobile electronic device 20 of the present invention can be embodied in a mobile phone, a notebook, a personal digital assistant, or a digital camera. The microcontroller 101 functions in processing, reading, writing, and retrieving data in the data communication chain, the external memory device connect interface 105, the flash memory 107, and the USB interface 103. The power supply 111 mainly provides the work power needed by all electronic components in the memory drive device and can be embodied in a battery or a rechargeable battery.

For practical application, the flash memory 107 of the memory drive device 10 of this present invention can be the backup storage device for the external memory device 30. At the same time, data in the mobile electronic device 20 can be saved in the flash memory 107 via the wireless transceiver module 109. Therefore, the flash memory 107 of the memory drive device 10 of this present invention can function as the backup storage device for the mobile electronic device 20. Furthermore, the memory drive device 10 of the present invention is connected to the computer 40. The data in the flash memory 107 can be retrieved and saved in the computer 40 and vice versa. The memory drive device 10 of the present invention possesses its own power supply 111 and is able to function independent of other power supplies.

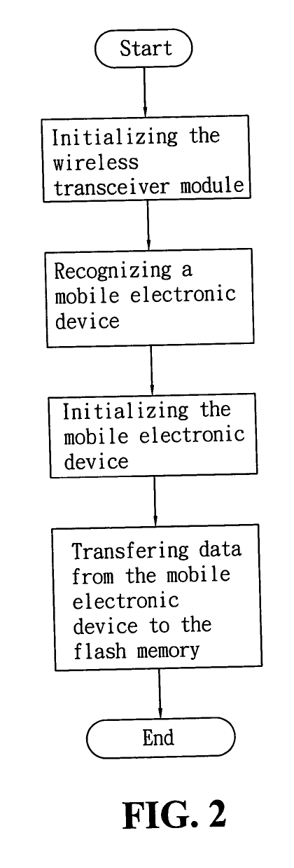

FIG. 2 shows the flow chart of the backup data process executed for the mobile electronic device of the present invention. At first, the microcontroller 101 initializes the wireless transceiver module 109. Followed, the microcontroller 101 recognizes and initializes any mobile electronic device 20 available. The protocol defined by the above mobile electronic device 20 will be adopted to transfer data from the mobile electronic device 20 to the flash memory 107 via the data communication chain of the wireless transceiver module 109 and the data transfer process executed by the microcontroller 101. The above completes the backup data process for the mobile electronic device 20 executed by the memory drive device 10.

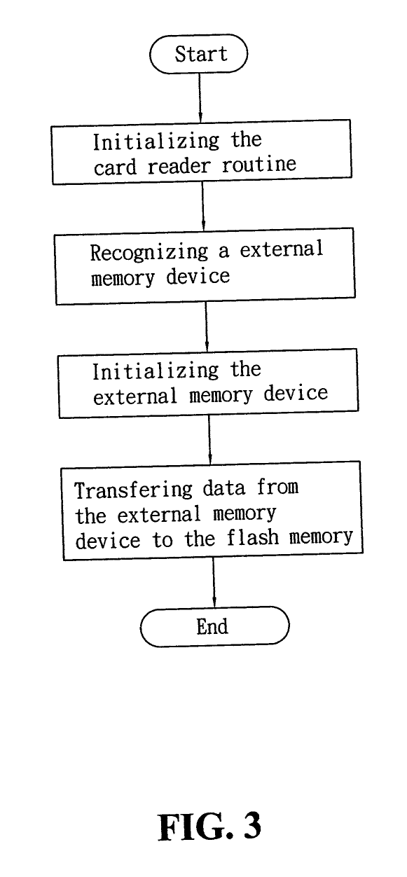

FIG. 3 shows a flow chart of the backup data process executed for the external memory device of the present invention. At first, the microcontroller 101 initializes the card reader routine. Followed, the microcontroller 101 recognizes and initializes any external memory device 30 available. The protocol defined by the above external memory device 30 will be adopted to transfer data from the external memory device 30 to the flash memory 107 via the external memory connect interface 105, which connects the flash memory 107 to the external memory device 30, and the data transfer process executed by the microcontroller 101. The above completes the backup data process for the external memory device 30 executed by the memory drive device 10.

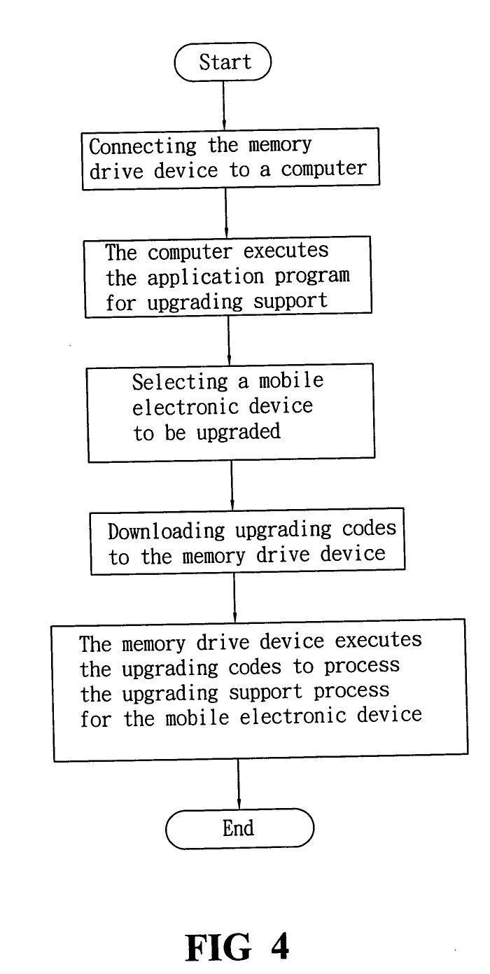

FIG. 4 shows a flow chart of the upgrading support process executed for the external memory device of the present invention. At first, the memory drive device 10 is connected to a computer 40 with a USB interface 103. Then, the computer 40 executes the application program for upgrading support and provides a list of external mobile electronic devices 20 to be selected. Followed the selection, the computer 40 will download the upgrading codes in accordance to the selected mobile electronic device 20 to the memory drive device 10. The memory drive device 10 executes the upgrading codes to process the upgrading support process for the mobile electronic device 20.

Moreover, the memory drive device 10 of the present invention can further comprise a laser indicator 115 for producing a laser beam. Thus, the laser indicator 115 will function as a laser pointer.

Moreover, the memory drive device 10 of the present invention can further comprise a general-purpose I/O (GPIO) 117 being connected to the microcontroller 115. A set of buttons for the memory drive device 10 is connected to the GPIO 117 and prompts the microcontroller 101 to execute any operation corresponding to the signals of the buttons.

Moreover, the memory drive device 10 of the present invention can further comprise a display device 113 for displaying the status of the memory drive device 10. The embodiment of such display device 113 includes a small LCD panel.

Many different embodiments of the present invention may be constructed without departing from the spirit and scope of the present invention. It should be understood that the present invention is not limited to the specific embodiments described in this specification. To the contrary, the present invention is intended to cover various modifications and equivalent arrangements included within the spirit and scope of the invention as hereafter claimed. The scope of the following claims is to be accorded the broadest interpretation so as to encompass all such modifications, equivalent structures and functions.

What is claimed is:

1. A memory drive device for wirelessly accessing data, comprising of:
an USB interface, connected to a computer;
a microcontroller for processing, reading, writing, retrieving and moving data;
a flash memory for storing said data, connecting to said microcontroller;
an external memory interface for providing a connection to an external memory device, connected to said microcontroller;
a wireless transceiver module for establishing a data communication chain with an external mobile electronic device, connected to said microcontroller; and
a power supply for providing the work power needed by said memory drive device.

2. The memory drive device according to claim 1, wherein said external memory devise is a CF card, a MMC card, a SD card, a MS card, a MS-PRO card, a SIM card, a SMARTCARD, or a CD writer.

3. The memory drive device according to claim 1, wherein said external mobile electronic device is a mobile phone, a notebook, a personal digital assistant, or a digital camera.

4. The memory drive device according to claim 1, wherein said wireless transceiver module is an infrared transceiver module.

5. The memory drive device according to claim 1, wherein said wireless transceiver module is a Bluetooth transceiver module.

6. The memory drive device according to claim 1, further comprising a display device for displaying the status of said memory drive device.

7. The memory drive device according to claim 1, further comprising a laser pointer for producing a laser beam.

8. The memory drive device according to claim 1, further comprising a general-purpose I/O (GPIO) connecting to said microcontroller.

9. The memory drive device according to claim 8, further comprising a set of buttons for controlling said memory drive device, being connected to said GPIO, sending out I/O signals to said microcontroller, and executing controlling operations corresponding to the I/O signals.
